(19) United States
(12) Patent Application Publication
(10) Pub. No.: US 2011/0056502 A1
(43) Pub. Date: Mar. 10, 2011

(54) Intubation Pillow

(75) Inventors: David T. Davis, Bethlehem, PA (US); John F. Englebert, III, Bethlehem, PA (US)

(73) Assignee: WOODLARK CIRCLE, INC., Bethlehem, PA (US)

(21) Appl. No.: 12/874,765

(22) Filed: Sep. 2, 2010

Related U.S. Application Data
(60) Provisional application No. 61/240,762, filed on Sep. 9, 2009.

(51) Int. Cl. A61G 99/00

(52) U.S. Cl. 128/845

(57) ABSTRACT

An intubation pillow formed by a base cushion that forms a torso-support portion and defines a recess sized and shaped so as to provide proper alignment of the oral, pharyngeal, and laryngeal structures forming a person's airway. A head-support cushion that is positionable within the recess is provided so as to provide proper alignment of the oral, pharyngeal, and laryngeal structures that form a person's airway such that unlabored normal breathing may be maintained both prior to and after an intubation procedure.

This application claims priority from copending Provisional Patent Application Ser. No. 61/240,762, filed Sep. 9, 2009, and entitled Intubation Pillow.

### FIELD OF THE INVENTION

The present invention relates to medical devices, and more particularly to an intubation pillow suitable for both easing patient breathing and aiding in the alignment of the oral, pharyngeal, and laryngeal axes of the airway of an obese individual when reclining, as well as supporting that persons head prior to and after such intubation procedure.

### BACKGROUND OF THE INVENTION

It is critical to modern surgical procedures that the air passages of the patient be maintained open throughout the duration of the surgical procedure. During surgery, the ability of the body to maintain an adequate airway may be compromised, such that airway management procedures are necessary to ensure that the airway remains open and unobstructed. Endotracheal intubation is routinely carried out in operating rooms after the induction of anesthesia to secure a patient's airway through placement of a breathing tube in the individual's trachea in order to facilitate either spontaneous or controlled gas exchange, and to establish and maintain an adequate airway. The endotracheal intubation process requires an unobstructed airway that is obtained by aligning the oral, pharyngeal, and laryngeal structures of the patient's body. Endotracheal intubation is usually carried out without great difficulty using an instrument, such as a laryngoscope, that exposes the individual's vocal cords.

Endotracheal intubation is usually performed using a laryngoscope having a straight blade or a curved blade on a reclining and anaesthetized individual. During the endotracheal intubation, and prior to the individual being connected to a breathing machine, the individual's breathing is mechanically assisted by a health professional physically moving air into the individual's lungs with a ventilation bag. Often, an endotracheal intubation consists of extending the individual's neck and rotating the head backwards in order to achieve alignment of the individual's oral, pharyngeal, and laryngeal axes. In normal sized individuals, i.e., a person having proper height to weight ratio, the alignment of the oral, pharyngeal, and laryngeal axes is aided by placing a standard pillow or small foam pillow under the individual's head and neck. Next, the individual's mouth is opened and the laryngoscope is introduced into the mouth. Then, the individual's vocal cords are exposed allowing the endotracheal tube to be inserted through the exposed vocal cords. The tip of the endotracheal tube includes an inflatable collar that is inflated to create a seal on the inside of the trachea. The exterior end of the tube is connected to a breathing machine that sustains the individual's breathing while under the anesthesia. Once the breathing tube is in place, a surgical procedure may begin. Following the surgical procedure, the individual is gradually brought out of the anesthesia. At that time, the breathing machine is disconnected, the endotracheal breathing tube is removed, and the individual begins breathing on his own.

Unfortunately, performing an endotracheal intubation on an obese individual is more difficult. During the endotracheal intubation, the physician attempts to align the oral, pharyngeal and laryngeal axes so that the endotracheal tube can be visually guided into the proper position. At the same time, the physician mechanically assists the obese individual's breathing by physically moving air into the obese individual's lungs with a ventilation bag. When working with an obese individual positioned on a prior art intubation pillow, the physician is at a mechanical disadvantage due to the abdominal mass of the individual pressing upward against the individual's diaphragm. To ventilate obese individual, the physician must exert enough force for the air pressure to move the individual's diaphragm against the weight of the individual's abdominal mass. In an obese individual, however, the large abdominal mass may be difficult for the physician to displace. Of course, a similar problem occurs following the surgical procedure when the obese individual is brought out of anesthesia and must begin breathing on his own. The obese individual must breathe with enough force to displace his abdominal mass with his diagram. Since the individual is still somewhat anaesthetized, it may be difficult for attending personnel to get the individual to breathe with enough force.

The magnitude of the problem of managing the airways of obese individuals may be more fully appreciated in view of statistics that indicate a significant percentage of adults in the United States are obese. As a consequence, a need has arisen for an intubation pillow that is capable of easing the breathing of obese individuals in a supine position. A need has also arisen for an airway management apparatus that aids in the alignment of the oral, pharyngeal and laryngeal axes in obese individuals.

### SUMMARY OF THE INVENTION

The present invention provides an intubation pillow formed by a base cushion that forms a torso-support portion and defines a recess sized and shaped so as to provide proper alignment of the oral, pharyngeal, and laryngeal structures forming a person's airway. A head-support cushion that is positionable within the recess is provided so as to provide proper alignment of the oral, pharyngeal, and laryngeal structures that form a person's airway such that unlabored normal breathing may be maintained both prior to and after an intubation procedure.

In another embodiment of the invention, an inflatable intubation pillow is provided having an inflatable base cushion that forms a torso-support portion. The inflatable base cushion defines a recess that is sized and shaped so as to provide proper alignment of oral, pharyngeal, and laryngeal structures forming a person's airway. An inflatable head-support cushion that is positionable within the recess is provided such that when the inflated head-support cushion provides proper alignment of oral, pharyngeal, and laryngeal structures forming a person's airway such that unlabored normal breathing may be maintained both prior to and after an intubation procedure.

In a further embodiment of the invention, an inflatable intubation pillow is provided that includes an inflatable base cushion that forms a torso-support portion. The inflatable base cushion defines a recess that is sized and shaped so as to provide proper alignment of oral, pharyngeal, and laryngeal structures forming a person's airway. An inflatable head-support cushion is provided that is pivotally attached to a portion of the base cushion so as to be positionable within the recess. In this way, when the head-support cushion is inflated, it provides proper alignment of oral, pharyngeal, and laryngeal structures forming a person's airway such that unlabored normal breathing may be maintained both prior to and after an intubation procedure.

In an alternative embodiment an intubation pillow is provided that includes a base cushion forming a torso-support portion and defining a recess sized and shaped so as to provide proper alignment of oral, pharyngeal, and laryngeal structures forming a person's airway. The base cushion has a plurality of transversely aligned air chambers structurally defined by a plurality of stringers that are affixed to, and extend between interior surfaces of the base cushion. Advantageously, at least two of the stringers are arranged so as to be longitudinally aligned with adjoining transversely aligned stringers so as to define a longitudinally aligned air chamber such that a lumbar support bulge forms in a lower region said base cushion above said longitudinally aligned air chamber upon inflation of said base cushion.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of an intubation pillow formed in accordance with the present invention;

FIG. 2 is a cross-sectional view of the intubation pillow as shown along section 2-2 in FIG. 1;

FIG. 3 is a perspective view of an intubation pillow, similar to that shown in FIG. 1, but with the head cushion pivoted away from the base cushion about a living hinge;

FIG. 4 is a cross-sectional view of the intubation pillow shown in FIG. 3;

FIG. 5 is a side elevational view of the intubation pillow shown in FIG. 1, with a patient lying upon the pillow;

FIG. 6 is a side elevational view of the intubation pillow shown in FIG. 1, with a patient lying upon the pillow, with the head cushion pivoted away from the base cushion about a living hinge;

FIG. 7 is a side elevational view of the intubation pillow shown in FIG. 1, with the head cushion deflated on the base cushion;

FIG. 8 is a side elevational view of the intubation pillow shown in FIG. 1 with the head cushion removed from the base cushion;

FIG. 9 is a perspective view of another embodiment of an intubation pillow formed in accordance with the present invention and providing improved lumbar support with a second inflatable pillow for post surgery patient comfort;

FIG. 10 is a perspective view of the intubation pillow shown in FIG. 9, with the internal baffle structure revealed in phantom;

FIG. 11 is a cross-sectional view of the intubation pillow shown in FIGS. 9 and 10;

FIG. 12 is a front perspective view of the intubation pillow shown in FIG. 9;

FIG. 13 is a rear perspective view of the intubation pillow shown in FIG. 9; and

FIG. 14 is a side perspective view of the intubation pillow shown in FIG. 9.

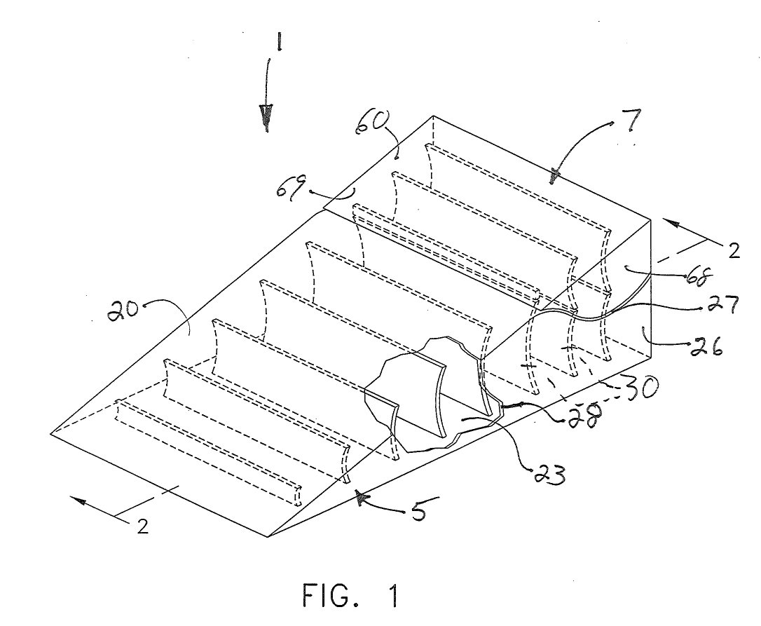

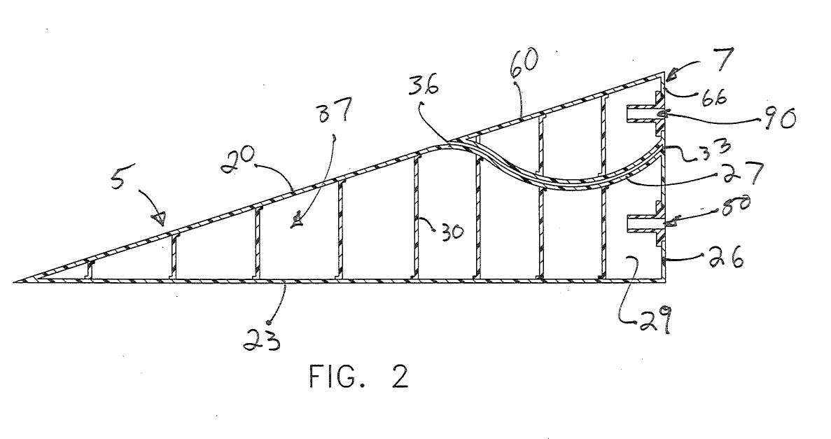

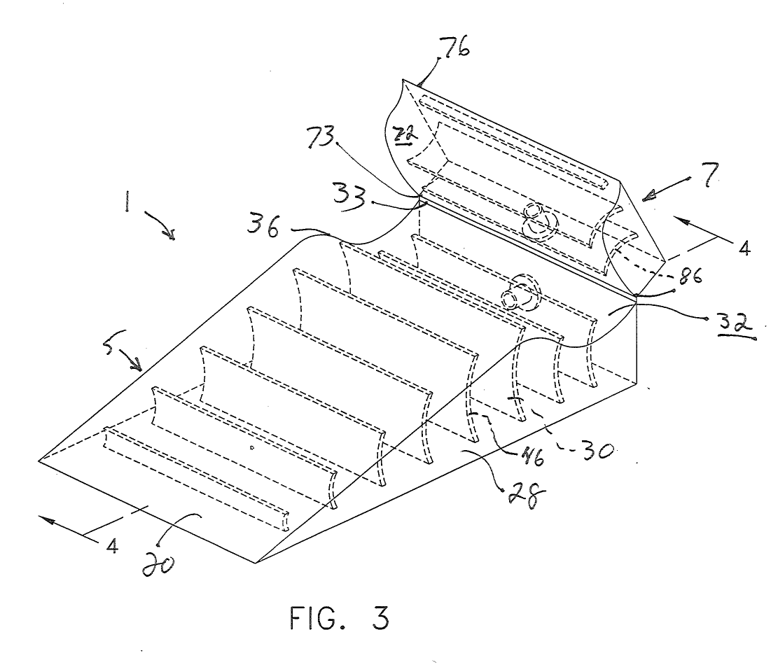

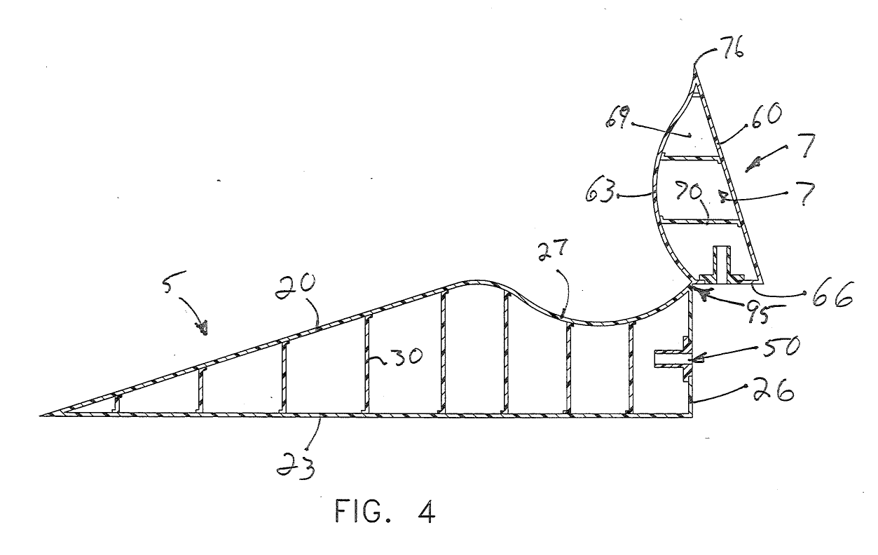

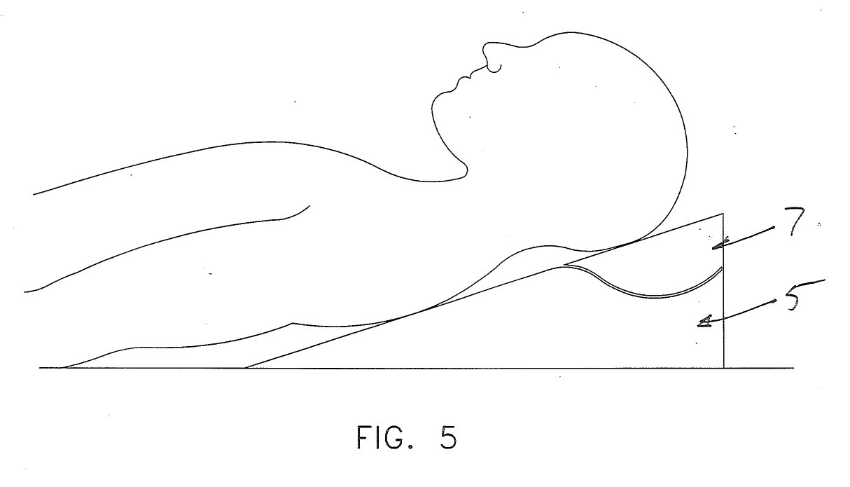

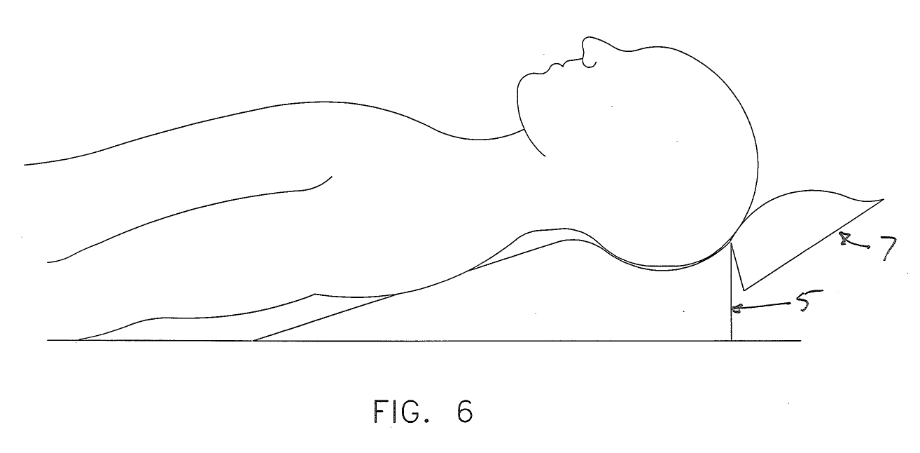

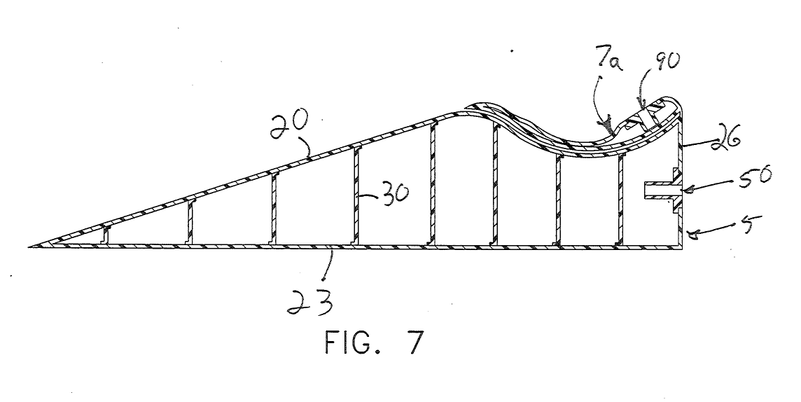

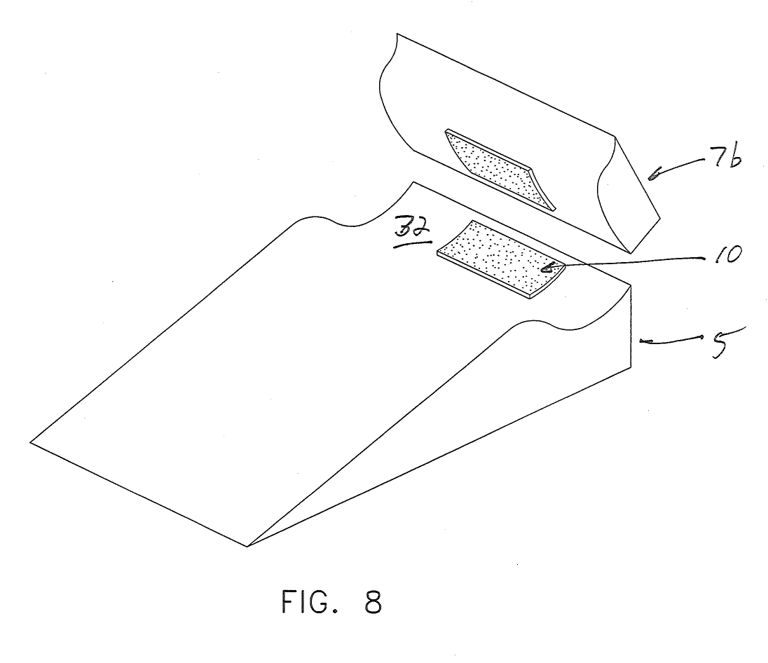

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. When only a single machine is illustrated, the term “machine” shall also be taken to include any collection of machines that individually or jointly execute a set (or multiple sets) of instructions to perform any one or more of the methodologies discussed herein. In the claims, means-plus-function clauses, if used, are intended to cover the structures described, suggested, or rendered obvious by the written description or drawings for performing the recited function, including not only structural equivalents but also equivalent structures.

The present invention provides an inflatable cushion 1 for use in supporting a patient's back, head, and neck during an intubation procedure. Inflatable intubation cushion 1 often comprises a wedge-shaped polyhedron having a base cushion 5 and a head cushion 7. Base cushion 5 includes a torso-support wall 20, a bottom wall 23, a back wall 26, a head-support wall 27 that is suitable for proper orientation of the oral, pharyngeal and laryngeal structures of the patient during an intubation procedure, two spaced-apart confronting triangular side walls 28, 29, and a plurality of interior stringers 30. Torso-support wall 20 is often formed from a discrete sheet of nylon scrim or the like, that may be coated on at least its outer surface with a water proof coating, such as any of the well known polymeric or elastomeric compounds that are known to be impervious to semi-solids and liquids, such as, blood, urine, feces, hospital strength disinfecting compounds, alcohol, or the like. Bottom wall 23 and back wall 26 may form portions of a single sheet of the same material or be discrete sheets. Side walls 28, 29 often comprise discrete sheets of the nylon scrim, that are arranged so as to be substantially parallel with one another and perpendicularly aligned with adjacent torso-support wall 20, bottom wall 23, and front wall 26. Head-support wall 27 defines a recessed portion of base cushion 5 that is defined by a concave surface 32 that extends from a top edge 33 of front wall 26 to an outwardly curved edge 36 defined at the junction between torso-support wall 20 and head-support wall 27. The curvature of concave surface 32 is selected so as to provide the proper intubation alignment of the oral, pharyngeal, and laryngeal structures forming a person's airway.

A plurality of transversely aligned air chambers 37 are structurally separated from one another and defined by stringers 30. Stringers 30 are affixed to, and extend between, the interior surfaces of torso-support wall 20 and bottom wall 23. Each stringer 30 comprises a substantially rectangular shape having a peripheral edge 46. Stringers 30 are attached to the interior facing surfaces of torso-support wall 20 and bottom wall 23 at regular intervals, so as to provide for reduced bulging of base cushion 5. A conduit 50 is provided front wall 26, and is sized and shaped so as to be attached to a source of pressurized fluid (not shown). Alternatively, a self-sealing valve may be positioned through one of either side wall 28 or side wall 29 so as to provide easy accessibility. Conduit 50 is often formed so as to be in fluid communication with the interior of base cushion 5 so that air is evenly distributed throughout all of air chambers 37 during inflation, but may exit during deflation.

Head cushion 7 is positionable within the recessed portion of base cushion 5 that is defined by a concave surface 32, and includes a top wall 60, a bottom wall 63, a back wall 66, two spaced-apart confronting side walls 68, 69, and a plurality of interior stringers 70. Top wall 60 is also often formed from a discrete sheet of nylon scrim or the like, that may be coated on at least its outer surface with a water proof coating, such as any of the well known polymeric or elastomeric compounds that are known to be impervious to semi-solids and liquids, such as, blood, urine, feces, hospital strength disinfecting compounds, alcohol, or the like. Bottom wall 63 and back wall 66 may form portions of a single sheet of the same material or be discrete sheets. Side walls 68, 69 comprise discrete sheets of the nylon scrim, that are often arranged so as to be substantially parallel with one another and perpendicularly aligned with adjacent top wall 60, bottom wall 63, and front wall 66. Bottom wall 63 comprises a convex, curved surface 72 that extends from a top edge 73 of front wall 66 to an edge 76 defined at the junction between front wall 66 and bottom wall 67. The curvature of convex surface 72 is complementary to concave surface 32 of base cushion 5, such that when head cushion 7 is fully inflated and located within the concavity defined by concave surface 32, the patient's head is supported for proper alignment of the oral, pharyngeal, and laryngeal structures of a person's airway such that unlabored normal breathing may be maintained both prior to and after an intubation procedure.

A plurality of transversely aligned air chambers 77 are defined by, and structurally separated from one another by stringers 70. Stringers 70 are affixed to and extend between the interior surfaces of top wall 60 and curved bottom wall 63. Each stringer 70 comprises a substantially rectangular shape with a peripheral edge 86. Stringers 70 are attached to the interior facing surfaces of top wall 60 and bottom wall 63 at regular intervals, so as to provide for reduced bulging of head cushion 7. A conduit opening 90 is provided front wall 66, and is sized and shaped so as to be attached to a source of pressurized fluid (not shown). Alternatively, a self-sealing valve may be positioned through one of either side wall 68 or side wall 69 so as to provide greater accessibility. Conduit opening 90 is often formed so as to be in fluid communication with the interior of head cushion 7 so that air is evenly distributed throughout all of the air chambers during inflation.

In one embodiment, head cushion 7 is pivotally fastened to base cushion 5 by a web 95 that forms a hinge. In this way, head cushion 7 may be pivoted about web 95, toward and away from concave surface 32. In another embodiment, head cushion 7a is fully fastened to base cushion 5 such that it may simply be deflated in order to facilitate the proper positioning of the patient's head during an intubation procedure. In another embodiment, head cushion 7b is wholly separate from base cushion 5 and may be held in place on concave surface 32 by fasteners, e.g., hook and felt fasteners 100.

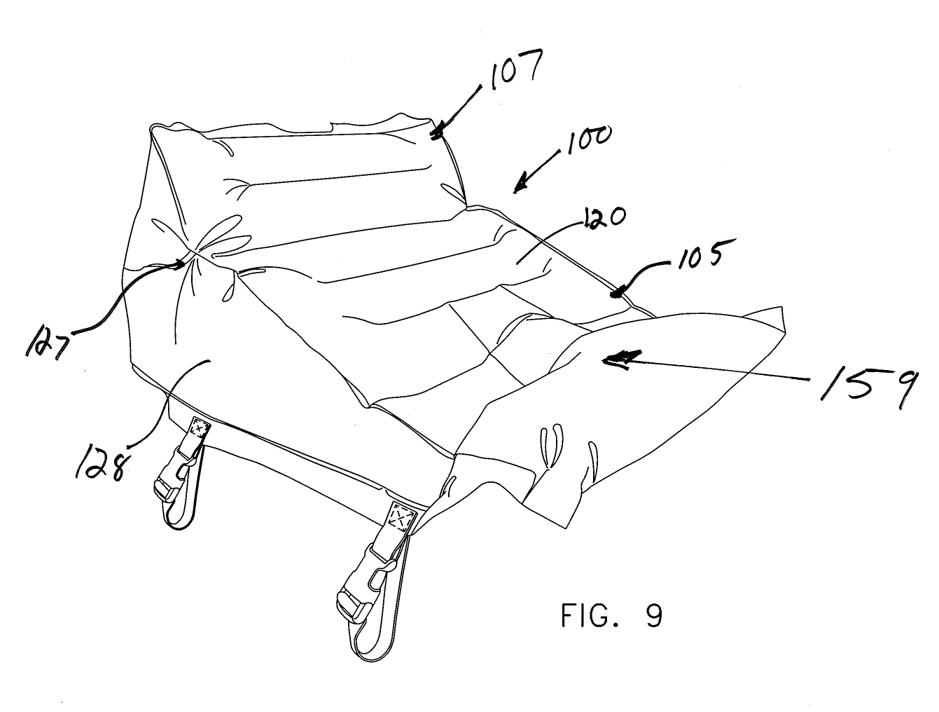

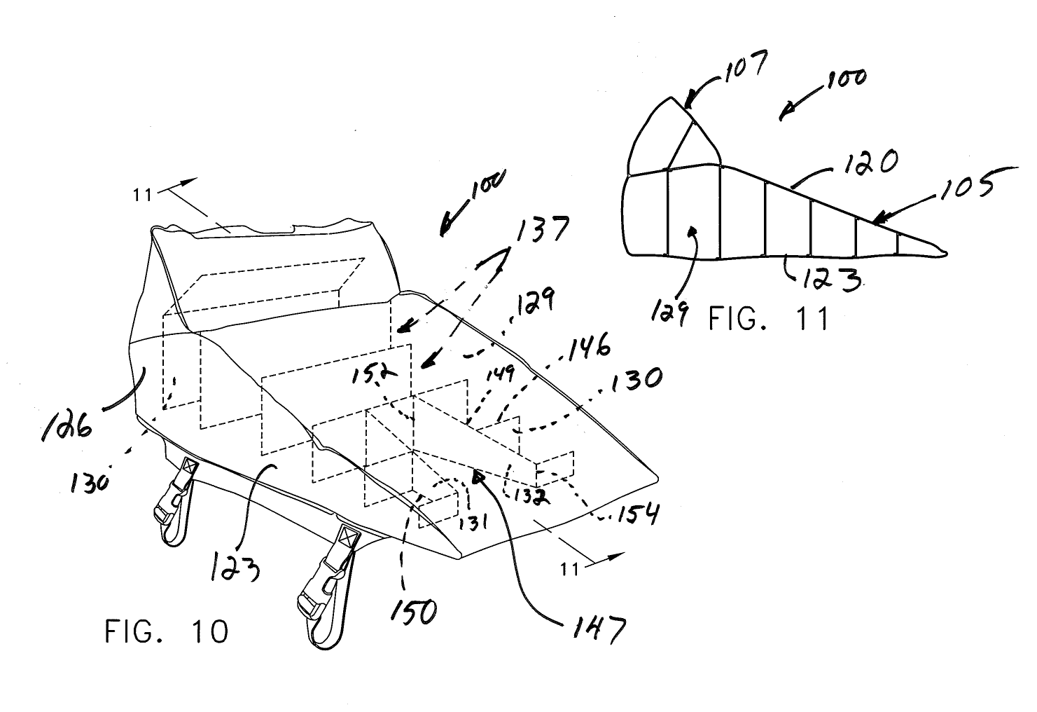

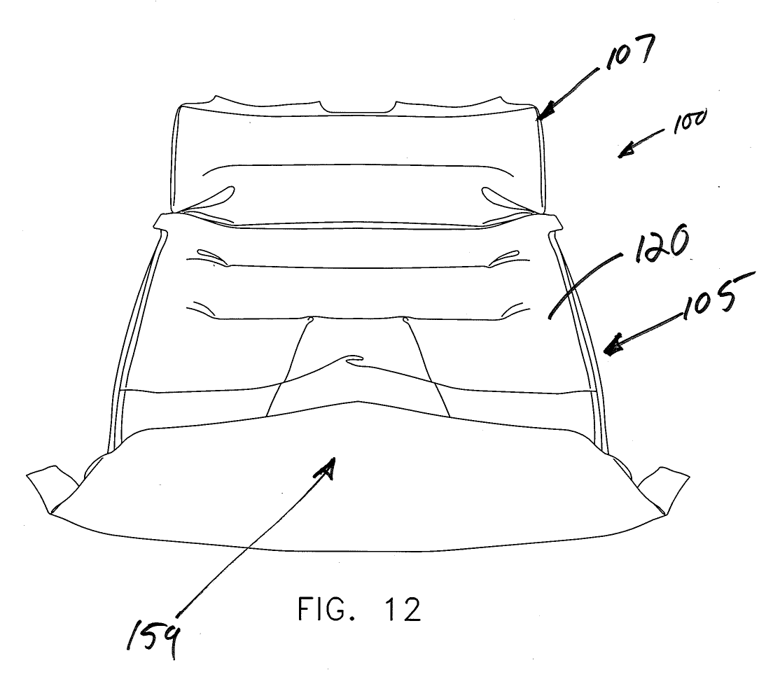

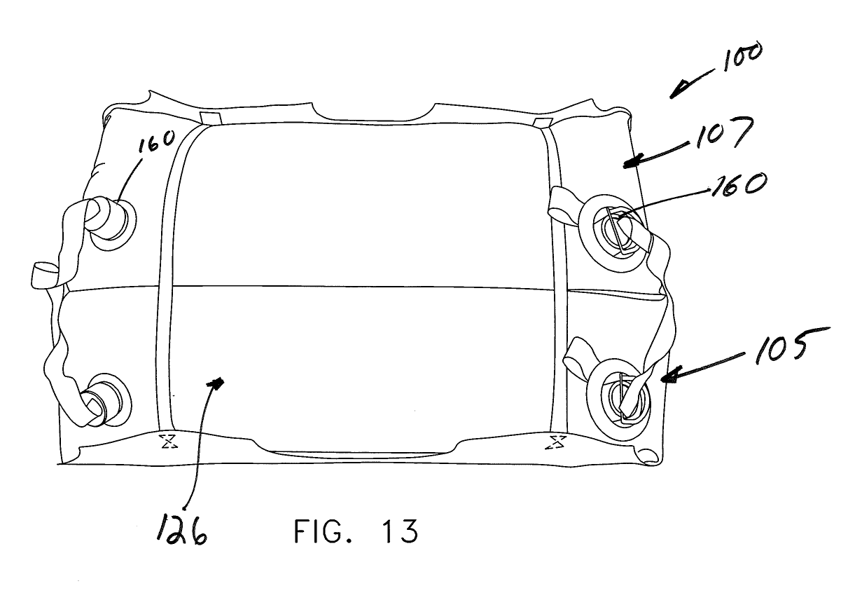

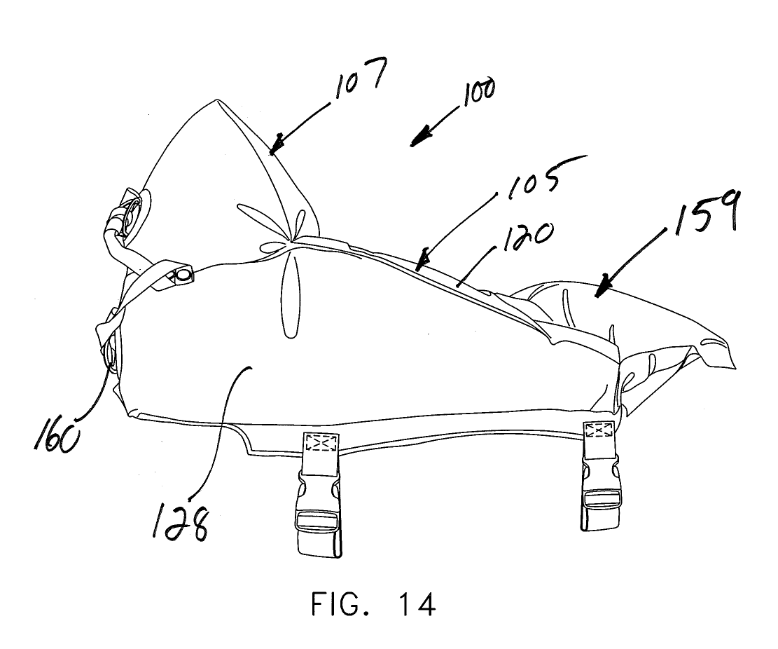

Referring to FIGS. 9-14, an alternative embodiment of the present invention also provides improved lumbar support as well as comfort to a post surgery patient. More particularly, an inflatable cushion 100 for use in supporting a patient's lumbar region, head, and neck during or after an intubation procedure, comprises a wedge-shaped polyhedron having a base cushion 105 and a head cushion 107. Base cushion 105 includes a torso-support wall 120, a bottom wall 123, a back wall 126, a head-support wall 127 that is suitable for proper orientation of the oral, pharyngeal and laryngeal structures of the patient during an intubation procedure, two spaced-apart confronting triangular side walls 128, 129, and a plurality of interior stringers 130. Torso-support wall 120 is also often formed from a discrete sheet of nylon scrim or the like, as disclosed hereinabove in connection with intubation 1. Bottom wall 123 and back wall 126 may form portions of a single sheet of the same material or be discrete sheets. Side walls 128, 129 often comprise discrete sheets of the nylon scrim, that are arranged so as to be substantially parallel with one another and perpendicularly aligned with adjacent torso-support wall 120, bottom wall 123, and front wall 126. Head-support wall 127 defines a recessed portion of base cushion 105 that is defined by a concave surface that extends from a top edge of front wall 126 to an outwardly curved edge defined at the junction between torso-support wall 120 and head-support wall 127. The curvature of concave surface is selected so as to provide the proper intubation alignment of the oral, pharyngeal, and laryngeal structures forming a person's airway.

A plurality of transversely aligned air chambers 137 are structurally separated from one another and defined by stringers 130, 131, and 132. Stringers 130 are affixed to, and extend between, the interior surfaces of torso-support wall 120 and bottom wall 123. Each stringer 130 comprises a substantially rectangular shape having a peripheral edge 146. Stringers 130 are attached to the interior facing surfaces of torso-support wall 120 and bottom wall 123 at regular intervals, so as to provide for reduced bulging of those portion of base cushion 105 where stringers 130 extend between torso-support wall 120 and bottom wall 123. Advantageously, a longitudinally aligned air chamber 147 is structurally separated from adjoining transversely aligned air chambers 137 by generally longitudinally aligned stringers 131 and 132. Stringers 131 and 132 also extend between and are affixed to torso-support wall 120 and bottom wall 123 in a similar manner to stringers 130. Each stringer 131 and 132 comprises a substantially trapezoidal shape having a top edge 149, a bottom edge 150, a proximal edge 152, and a distal edge 154. Proximal edges 152 are affixed to an internal surface of an adjoining stringer 130, and are often longer than distal edges 154. Stringers 131 and 132 are arranged within intubation pillow 100 such that the distal edges 154 are spaced apart from one another by a distance that is greater than the distance separating proximal edges 152 so as to define longitudinally aligned air chamber 147. In this way, lumbar support a bulge 159 forms in the lower region of torso-support wall 120, above longitudinally aligned air chamber 147, upon full inflation of intubation pillow 100. This structure provides for improved lumbar support and patient comfort.

A plurality of conduits 160 are provided front wall 126, and are sized and shaped so as to be attached to a source of pressurized fluid (not shown). Alternatively, a self-sealing valve may be positioned through one of either side wall 128 or side wall 129 so as to provide easy accessibility. Conduits 160 are often formed so as to be in fluid communication with the interior of base cushion 105 so that air is evenly distributed throughout all of air chambers 137 during inflation, but may exit during deflation.

It is to be understood that the present invention is by no means limited only to the particular constructions herein disclosed and shown in the drawings, but also comprises any modifications or equivalents within the scope of the claims.

What is claimed is:

1. An intubation pillow comprising:
a base cushion forming a torso-support portion and defining a recess sized and shaped so as to provide proper alignment of oral, pharyngeal, and laryngeal structures forming a person's airway, said base cushion including a plurality of transversely aligned air chambers structurally defined by a plurality of stringers that are affixed to, and extend between interior surfaces of said base cushion, wherein at least two of said stringers are arranged so as to be longitudinally aligned with respect to adjoining transversely aligned stringers so as to define a longitudinally aligned air chamber such that a lumbar support bulge forms in a lower region of said base cushion above said longitudinally aligned air chamber upon inflation of said base cushion; and
a head-support cushion that is positionable within said recess so as to provide proper alignment of oral, pharyngeal, and laryngeal structures forming a person's airway such that unlabored normal breathing may be maintained both prior to and after an intubation procedure.

2. An inflatable intubation pillow comprising:
an inflatable base cushion forming a torso-support portion having a lumbar support bulge, and defining a recess sized and shaped so as to provide proper alignment of oral, pharyngeal, and laryngeal structures forming a person's airway; and
an inflatable head-support cushion that is positionable within said recess such that when said head-support cushion is inflated and positioned within said recess, proper alignment of oral, pharyngeal, and laryngeal structures forming a person's airway is achieved such that unlabored normal breathing may be maintained both prior to and after an intubation procedure.

3. An inflatable intubation pillow comprising:
an inflatable base cushion forming a torso-support portion and defining a recess sized and shaped so as to provide proper alignment of oral, pharyngeal, and laryngeal structures forming a person's airway; and
an inflatable head-support cushion that is pivotally attached to a portion of said base cushion so as to be positionable within said recess such that when said head-support cushion is inflated and positioned within said recess, proper alignment of oral, pharyngeal, and laryngeal structures forming a person's airway is achieved such that unlabored normal breathing may be maintained both prior to and after an intubation procedure.
